(19) United States
(12) Patent Application Publication
(10) Pub. No.: US 2015/0215187 A1
(43) Pub. Date: Jul. 30, 2015

(54) Data Services in a Computer System

(71) Applicants: Janne Einari Tuononen, Nummela (FI); Hannu Flinck, Helsinki (FI); Ville Petteri Poyhonen, Espoo (FI)

(72) Inventors: Janne Einari Tuononen, Nummela (FI); Hannu Flinck, Helsinki (FI); Ville Petteri Poyhonen, Espoo (FI)

(21) Appl. No.: 14/422,017

(22) PCT Filed: Aug. 17, 2012
(86) PCT No.: PCT/EP2012/066081

§ 371 Date: Feb. 17, 2015

(51) Int. Cl. H04L 12/26; H04L 29/06

(52) U.S. Cl. CPC H04L 43/10; H04L 63/1416; H04L 63/1458

(57) ABSTRACT

In a method and apparatus for a data communication system data sessions provided in response to service requests are monitored. Based on the monitoring information regarding data communicated from at least one data source during the monitored sessions is determined. Statistical information is collected based on the determination(s). Performance of at least one operation is caused based on the statistical information.

This disclosure relates to a computer system where data services, for example content downloads, can be provided to users connected to a data communication system.

A communication system can be seen as a facility enabling communication between two or more communicating apparatus such as user devices or terminals, servers, relay nodes, gateways, access points and/or other nodes. A user can access a communication system by means of an appropriate communication device or terminal. Data communications can be provided by wireless or fixed line carriers.

Efficient data communications such as content delivery is a challenge in a communication system. Presently, most network architectures are based on an “End-to-End” Communication paradigm where data communication is provided between two fixed, or near fixed points in the system. For example, a first fixed point of a user device (e.g. a personal computer) requests content from a second fixed point (e.g. a server) and receives the requested content via a particular route or path through the data communication system. One or more interconnected local networks may be located on the path.

In accordance with a scenario end user usage models and applications move towards information centric networks where the location of the information, e.g. content, is less relevant since the routing is based on content centric naming schemes instead of host addresses. A proposal to improve efficiency of content delivery is to cache content data. For example, a proactive caching mechanism (PCM) for an information centric network (ICN) may be provided to enable an enhanced and more efficient scalability, resource usage and performance. Caching can be provided in current network architectures, e.g. the Internet, to enable the benefits of ICNs on current network architectures as well as provide architecture for future network implementations.

Content data can be cached to local storages. However local caching, or caching in general, may not be appropriate or even feasible for all content sessions. For example, at least some of the content may be of such nature and/or requested so seldom that caching thereof might not provide any meaningful benefit. Also, managing storage of content data in locations other than the actual service provider servers or the like can be a challenging task. This may be so for example because of changes in user behavior, rapidly ageing content data and security risks.

Embodiments of the invention aim to address one or several of the above issues.

In accordance with an embodiment there is provided a method for a data communication system, the method comprising monitoring data sessions provided in response to service requests, determining, based on the monitoring, information regarding data communicated from at least one data source during the monitored sessions, collecting statistical information based on the determining, and causing performance of at least one operation based on the statistical information.

In accordance with an embodiment there is provided an apparatus for a data communication system, the apparatus being configured to determine, based on monitoring of data sessions provided in response to service requests, information regarding data communicated from at least one data source during the monitored sessions, collect statistical information based on the determining, and cause performance of at least one operation based on the statistical information.

In accordance with a more detailed aspect, the at least one operation comprises controlling storing and/or deletion of content data, and/or controlling local caching of content data and/or evicting of locally cached content data, and/or publishing and/or un-publishing locally available content data, and/or determining possibility of a denial of service attack.

The monitoring may comprise monitoring for downloads in association with a local node of a radio system serving a requestor.

The determining may comprise reading header information from the data communicated during the session and using the header information in determining the proportion of a full data file that was actually communicated.

Information contained within headers of content data may be analysed to determine characteristics of downloaded content such as duration of a video or audio file, codec, screen resolution and bitrate.

The monitoring may comprise identifying content data.

The statistical information may be based on information about actual usage of content data.

Information on use of different fractions of content data may be provided. At least one operation on at least one fraction of the content data may be provided based on the information.

The proportion of data that was delivered of a full data file may be determined.

Data sessions may be monitored by a plurality of information collection points that reports information to a collection point.

Popularity of a particular data may be determined.

The monitoring may be provided on a data path between a content provider and a requestor. According to another embodiment at least a part of the monitoring is provided off the data path between a content provider and the requestor based on a duplicate of content data downloaded by the requestor.

At least one local content storage may be selected and content may be downloaded to or removed from the selected local data storage.

Content data may be analysed to create additional information for the control operations describing at least one characteristics of the content.

A computer program comprising program code means adapted to perform the herein described methods may also be provided. In accordance with further embodiments apparatus and/or computer program product that can be embodied on a computer readable medium for providing at least one of the above methods is provided.

Various other aspects and further embodiments are also described in the following detailed description of examples embodying the invention and in the attached claims.

The invention will now be described in further detail, by way of example only, with reference to the following examples and accompanying drawings, in which:

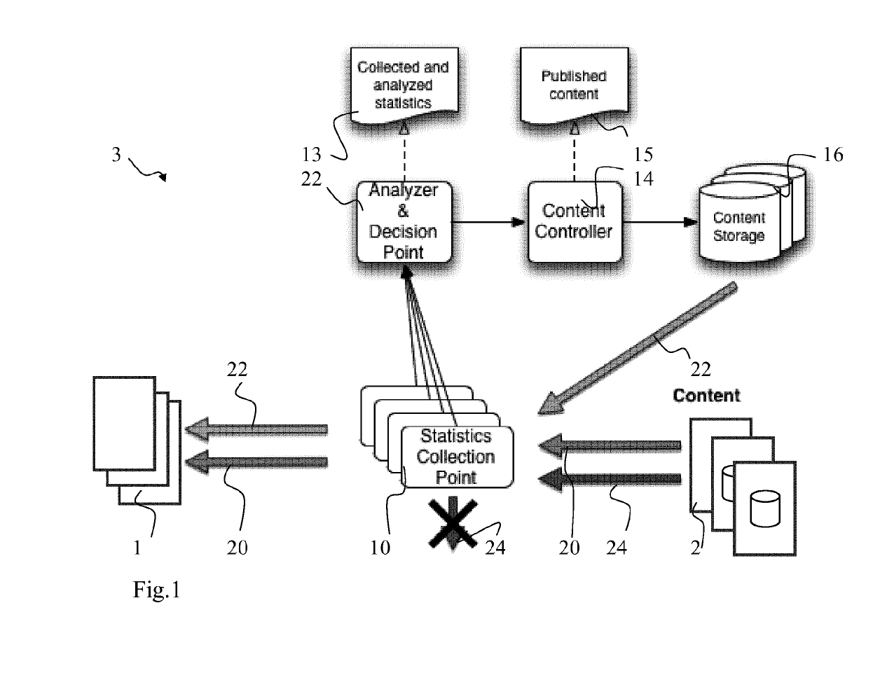

FIG. 1 shows a schematic diagram of an arrangement of logical entities in accordance with an embodiment;

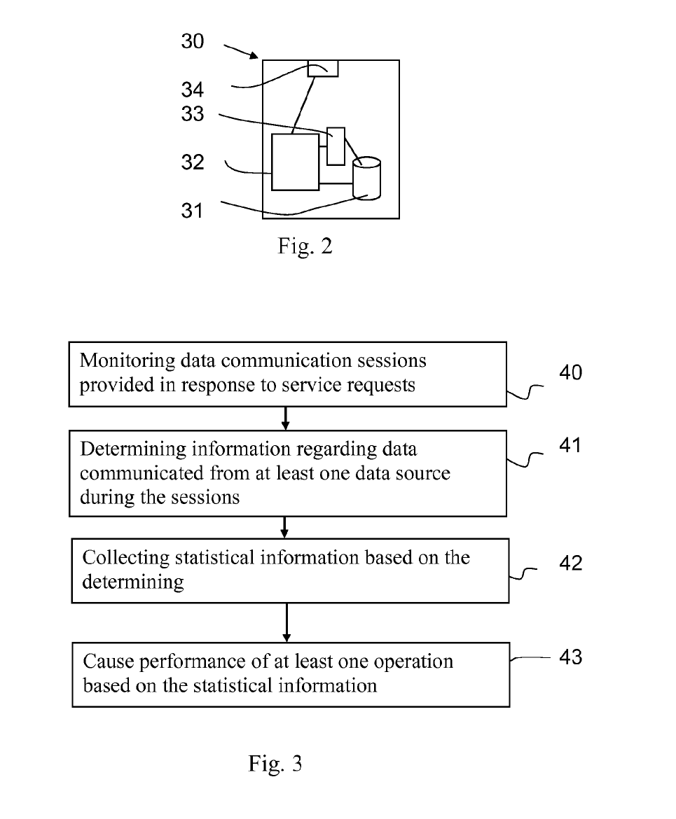

FIG. 2 shows a schematic diagram of a control apparatus;

FIG. 3 shows a flowchart according to a certain embodiment; and

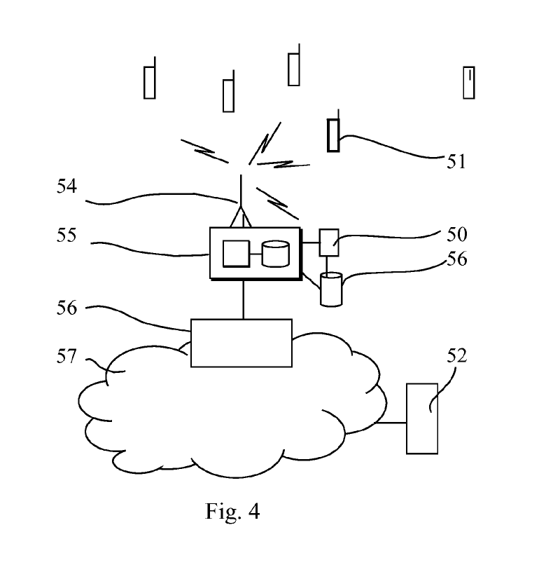

FIG. 4 shows an example of a communication system where the invention can be embodied.

Before explaining the various functional components thereof in detail, a brief description of a content delivery system is given with reference to FIG. 1. FIG. 1 shows a simplified schematic block diagram of a computerised system where certain embodiments of the invention may be provided. A plurality of communication devices or user terminals 1, for example desktop, laptop or tablet computers, smartphones or other mobile user equipment (UE) can be operatively connected to a data communication system 3. The data communication system can be provided by one or more network operators. The user terminals may access the communication system via wireless or fixed connections.

Various data sources are accessible for the users of the terminal devices 1 via the data communication system. A user terminal can request for data and in response thereto download data from various sources. The downloading may take place from one or more local data storages 16 and one or more data storages of content providers. The local storages 16 may be provided by one or more caches. The caches can be provided by means of local content servers that are under control of a content control entity 14. The content providers may provide the content for example by means of content servers 2. The local content servers and the service provider content servers are separately operated logical entities.

The data communication system may include several functions and systems to enable operation of the network and provisioning of requested data services to the users, e.g. infrastructure, network management systems, billing systems, and so on. These, however, are not essential for understanding the operation of the herein described arrangements for monitoring content downloads in response direction and use of the obtained information, and will therefore not be described in any detail herein.

An example of content that can be provided for the end users is video content. Currently video content is one of the growth areas both in fixed and mobile networks. However, other types of content where high data volumes may need to be delivered are also possible.

To support the amount of data traffic caused by increasing amount of requests for high data volume content bandwidth and transport capacity may need to be increased both in the access and transit side of the communication system. Also, caching and Content Delivery Networks (CDN) may be deployed. CDNs are meant for primary content downloads and there is typically a contractual relationship between the CDN operator and the content provider. Caching in turn can be provided as a local optimization to improve quality and to lower transit costs by bringing the content closer to the edge of the network. Caching does not necessitate a relationship between the provider of caching facility and the content provider.

The following describes examples for response direction content monitoring in a computerised systems. Information from the response direction content monitoring can be used as a basis for example of content storing decisions. The information can be utilised to achieve optimal resource usage and cost savings by storing only such content or parts that are determined being potentially used by content requestors.

In various scenarios the location where data such as content data is stored may no longer be as important as it were in the end-to-end scenarios. This can be so for example in relation to the so-called cloud computing paradigm, where the routing of requests for content can be based on the content rather than on a fixed end point where the content is located. Therefore, presently the end user usage model and applications are moving towards information centric and the so-called publish/subscribe paradigms. The term the “cloud computing” shall be understood to encompass all technologies that can be used to provide computation, software, data access, and storage services that do not require end-user knowledge of the physical location and configuration of the system that delivers the services. The concept provides flexibility, optimization of resources and as a consequence more applications/services are provided by means of a cloud.

In accordance with an embodiment a monitoring facility is provided by a logical entity providing a statistics collection function. The statistic collection function can be provided by one or more statistic collection apparatus 10. Such an apparatus can be provided in an element or module in a network on the path to the end user device i.e. requestor 1. The apparatus may be provided in a local network close to the end user 1 and/or a network of the provider of data communication services for the end user 1.

The apparatus providing the statistic collection function 10 can be configured to monitor defined application sessions in a response direction, i.e. direction from content sources 2 and 16 to the end user 1. The monitoring can be focused on content downloads. The monitoring can be based on predefined policies. Results of the monitoring can be used e.g. as a basis of caching decisions or other decision in relation to storing and/or managing content data deliveries and analysis of the data communications, for example for detection of possible denial of service (DoS) attacks.

The monitoring can include operations for identifying the content. For example, calculation of hashes or partial hashes online over the content that is being downloaded can be performed to identify the content. In addition to content identification the statistic collection point may provide a deeper analysis e.g. on video content to create additional metadata based on the information contained within e.g. video headers to assist in making caching decisions. For example, characteristics of downloaded content such as duration of a video or audio file, codec, screen resolution and bitrate, may be provided by analysing only the beginning of a file, e.g. a video or audio file. In certain occasions it may be enough if the first 20 Kbytes of data of a large file is analysed.

A statistic collection point 10 can provide information on its findings from the service sessions to other logical entities in the system. Report generated by each statistic collection point based on the monitoring can include information for other logical entities of the system to enable execution of their tasks. The information can comprise e.g. content ID, characteristics of the content and statistical information.

An analyser and decision function 12 may be provided for storing and keeping a count on content reports by one or more statistics collection points 10. The analyser and decision function or point can instruct a functional entity such as a content controller 14 based on its policies. Instructions can be sent e.g. when a predefined trigger event is determined, e.g. when a certain criteria is met and short/mid/long-term storing of the content should be provided. The analyser and decision point can be physically located in a separate entity or in connection with one of the data collection points.

The content control element 14 can be adapted to receive caching indications or other instructions from the analyser and decision function 12. In response thereto appropriate content storage(s) may be chosen and these commanded to download and store the content. The controller can be located in a separate entity or provided in connection with the data collection point and/or analyser and decision point.

At least one content storage 16 for storing content data is also provided. The storage may be provided for example by means of a local content server. The local content storage 16 is adapted to receive a store command, download the requested content, as any client, from the content source 2. When a download has finished, the content storage can register the content back to the content controller. The content controller can thus, upon receiving the publish signal, become aware of the new copy of the content in one of its managed storages. As with the other functional elements, the content storage can be provided as a separate entity or in connection with any of the elements discussed above.

An embodiment provides a system for collecting statistics from the content downloaded via application sessions from content providers 2. Statistics can also be collected from downloads from the local storages 16. Cache management decisions are then made based on the collected statistic. A plurality of statistic collection points 10 can be located in a distributed manner in a data communication system such that they are located “on-path” (content arrows 20 and 22 in FIG. 1) where they can have a good visibility on all content downloaded by a multiple of users 1 and thus can collect content/session specific statistics.

Having statistics collection points on-path between the content source(s) and the requestors provides a facility to monitor how much of content, if any, was in reality consumed by the requestors. The statistics collection point 10 can be provided on the path of data flows from the source to the requestor such that data sessions are routed through the statistics collection point. Transport protocols and sizes of the content files to be downloaded can be used as a basis of determinations. For example, information visible in the protocol headers can be used to extract required attributes of a video content. The statistic collection point can determine, based on information of the size of the requested file and determination of how much of data is actually transferred if all or just a fragment of the requested content was downloaded.

A statistics collection point can be used to monitor also sessions from the content storage managed by the content controller (arrow 22 in the FIG. 1). This enables use of both positive and negative popularity rating of stored full content objects or its fractions (chunks). With this information content data that has been requested but not consumed more than fractionally can be removed (or parts of it in case the content is stored as chunks) from the storage. Typically the beginning of the content is more popular than the end thereof, especially in the case of video/audio data. It is possible to add granularity to the popularity inside the content based on statistic on usage of fractions of content data.

This information can be used in managing the local storage facility to optimise the amount of data to be communicated from the content providers 2. For example, there is a considerable difference if only tens of seconds of a multi-hour movie is delivered from the content provider compared to delivering the full movie. Thus granularity can be added to content download statistics collected for content caching decisions. For example, only a fraction of a full file may in reality be consumed by one or more requestors. In such case it could be a waste of storage and/or transport capacity to store the full file in a local cache, especially if the file is e.g. a video file that can contain several Gigabytes of data. To address this, the rule can be, for example, that the file is stored only if the popularity thereof justifies the storing. Also, only the fraction of the file that has been determined as being sufficiently popular may be stored locally.

When a statistic collection point 10 has collected the statistics, it can compile and send a report to the analyser and decision point 12 collecting reports from a plurality of relevant collection points. Therefore, the analyser and decision point can have an overall view of all collected statistics and can maintain a system wide statistic database for cached content and for non-cached monitored content. The analyser and decision point may make decisions on whether some content should be cached or not. Also, a decision can be made whether some cached content should be evicted or not.

The analyser and decision point may use among others information about the fractions of requested content that were actually consumed/downloaded to the requestor. In case of a cache management decision is made the content in the local storages 16 can be changed by adding a new content and/or removing an existing one. The analyser and decision point may instruct the content controller what to do in general and/or with a specified content.

In case of “cache” command is determined appropriate, the content controller 14 may select the best storage server(s) and instruct it(/them) to download and store the content. Once the content has been successfully downloaded, the relevant content storage entity 16 can register (i.e. publish) the new stored content to the content controller. The content controller can then update a publication database 15.

Content can also be removed from the local storage based on the monitoring. If the content controller receives an “evict” command, it can check for the relevant content storage(s) and instruct these to evict the specified content. Once the deletion is done, the content controller can un-publish the deleted content.

A publication database can be maintained with up-to-date information about locally available content. This information can be used for any new service requests to check whether the requested content can be served from a local cache or not.

The analyser and decision function can collect reports from statistics collection point(s) and keep count on content popularity based on the information provided in them. The popularity can be measured using a fully served or sufficiently served request counts. In addition to, or instead of, information of the number of fully served or almost fully or sufficiently served request, information about their frequency can be used when rating popularity.

Non-consumed request can also be counted (if these are reported) as these may be useful for the analysis. For example, this information can be used when analysing what type of content is popular in the network at a certain point of time or in case of monitoring the sessions from the content storages.

The content controller may maintain for content storage monitoring a weighted average over the chunked content part to support the positive/negative popularity rating and addition/removal of content as result of that.

For the statistic collection point(s), the arrangement can be such that it does not matter whether the origin of the content to be monitored is stored in a local network domain such as a local storage 16 or elsewhere, for example an external service provider server 2 in the Internet.

In accordance with certain embodiments “off-path” information collection points are provided. An off-path collection point can download content and collect statistics without actually storing the content. This is indicated by content arrows 24 in FIG. 1. For “off-path” statistic collection cases, a content download can be duplicated such that there is one for an application session of a user and another for a statistic collection point. This can be provided for example by duplicating a content flow at a certain point on the data path or by establishing separate identical session from a statistics collection point to the content source or by using a proxy like approach where a statistics collection point is provided as an intermediate entity or a “middle box”. When monitoring is done for sessions that have end points off the path from a statistics collection point, response content monitoring can be triggered e.g. by the content controller.

Various events can trigger content storage related operations. A possible trigger for a storing decision by the analyser and decision point is the popularity of the content. The trigger can be based on a popularity metric. For example, any content (or fraction of content) whose popularity exceeds a predefined threshold is stored.

As mentioned above, non-consumed responses can also be counted and information thereof used as a basis for caching decisions. However, if non-consumed responses are used as a basis for positive caching decisions, this can in certain occasions result wasteful use of cache storage resources and/or make the system vulnerable to denial of service (DoS) attacks. A DoS attack could potentially block cache and/or other resources by irrelevant content data. To address this the decision algorithm can be adapted such that the popularity metric is not influenced by content requests that do not result an actual delivery of content, or which do not result a delivery of a sufficient amount of content data.

To illustrate this, consider e.g. usage of a video sharing site where a possible usage pattern is that an end user may initiate several requests while not viewing any of them fully, or viewing them only briefly/partly. Response direction monitoring can be adapted to identify content that has actual meaning for the end user and/or where a high enough amount of content is delivered for triggering a statistical count. The threshold for fully or sufficiently served response can be provided as a programmable parameter. The parameter may, for example, indicate the size of a fraction of the full content file that needs to be actually downloaded (or consumed) to the requestor for it to count for the statistical analysis.

A video file can be delivered as a single full file (progressive download) or in chunks. In Hypertext Transfer Protocol (HTTP) the latter is known as adaptive streaming (HAS). In HAS the client can request for chunks separately based on a manifest file provided at the beginning of the download. In HAS a common chunk size is 10 s.

Even if progressive downloading uses full video files these can be divided into chucks or fragments of certain size, for example 10 s. This can be expressed e.g. as follows. FF (full file) denotes the size of a complete requested content file. The size of the full file can be concluded at the start of the session by analysing the content. Subsequent chunks or fragments (byte ranges) of the file are denoted with frag1, frag2, frag3, . . . fragN where FF=frag1+frag2+ . . . fragN. A popularity coefficient cpop(i)=frag(i)/FF is assigned for each such fragment that was downloaded, e.g. the data session was not disconnected at this point, otherwise cpop(i) is set to 0. The requested full file can be ranked based on the used caching algorithm, FFrank The caching algorithm as such is not necessarily affected by this. Instead, the effect is achieved by associating the fragments and chunks with a ranking of a cache algorithm based on whether a particular fragment/chunk was downloaded or not.

Popular fragments may be cached according to the FFrank of the used cache algorithm if cpop(i) coefficient exceeds a given threshold, the default value of the threshold being higher than 0. The full file can be cached as per the rank of the used caching algorithm if FF=a*(cpop(1)*frag1+cpop(2)*frag2+ . . . ), where a is programmable parameter. An example of parameter a is explained below as “sufficient amount”. Fragments could be 10 seconds worth of video in case of progressive download or chunks in case of HTTP adaptive video.

A “sufficient amount” can be for example an amount that is dependent on various parameters, such as content size and content type etc. The policies guiding the monitoring can be arranged to adapt to the parameters. A statistics collection point may include in its reports information on requests that resulted a sufficient amount of content delivery and requests that resulted only a negligible fraction of delivery. This information can be reported with other related statistics and additional metadata. The information can be used by the analyser and decision point to allocate cache capacity for content that is actually used. This may be used to assist in obtaining e.g. savings in transport of data.

An early detection of a potential Denial-of-Service (DoS) attack can be provided based on the monitoring and analysis. This aspect can be relevant for any content provisioning system and not just content caching systems. For example, it can be determined that a server is subjected to a great number of service requests where only a minuscule amount of data, or no data is actually downloaded. For example, from the ratio of requests (e.g. number of request for a full file) and actual downloads (e.g. number of downloads of individual fragments) it can be determined whether the requests are genuine or not. For example, a threshold can be set for the ratio of requests and actual downloads. Exceeding thereof would trigger an action mitigating the effect of a suspected DoS attack. For example, requests for full files that are determined as being a part of a potential DoS are not considered as an indication of popularity and would thus not contribute towards a positive caching decision.

The statistics collection point can also be arranged to generate content identifier(s) for the monitored content. The identifiers can be unique on the system level. One way of doing that is to calculate at least partial hash(es) over the content. The content based hashes can be used for later identification of the same content even if the content was requested via different possibly dynamically changing URL.

The statistics collected by the statistics collection points can be used to complement other customer experience management statistics. If combined with video/audio analysis tools it is possible to create metadata to further improve the caching decisions and value of the statistics.

FIG. 2 shows an example of a control apparatus that is suitable for embodying the invention. The control apparatus 30 may, for example, be coupled to and/or for controlling storage operations in one or more local service areas. It is noted that in some embodiments a separate control apparatus may be provided for each or at least some of the above described logical entities and in some other at least some of them or all of them are provided by a single control apparatus.

The control apparatus 30 can be arranged to provide the monitoring, determining, collecting and/or control functions as described herein in a communication system. For this purpose the control apparatus comprises at least one memory 31, at least one data processing unit 32, 33 and an input/output interface 34. Via the interface the control apparatus can be coupled to other entities, for example to entities of the communication system carrying the content data. The control apparatus can be configured to execute an appropriate software code to provide the control functions.

An example of operation is described with reference to flow diagram shown in FIG. 3. Users can send requests for content to a communication system. The requests for content are responded by at least one content source, for example by an external content provider. The content may also be provided from a local cache that is managed based on monitoring of content downloads. The downloads can be monitored at 40 by at least monitoring entity collecting statistical data of the responses and adapted for monitoring communication sessions provided in response to service requests. Information can be determined at 41, based on the monitoring, regarding data communicated from at least one data source during the sessions. Statistical information is collected at 42 based on the determining. This information is then used in causing performance of at least one operation at 43.

Various operations are possible based on the statistical information. Storing and/or deletion of content data anywhere can be controlled based on the collected statistical information. Local caching of content data and/or evicting of cached content data may controlled. Publishing and/or un-publishing locally available content data may be provided based on the information. According to a possibility of a denial of service attack is determined based on the collected information.

For example, based on the monitoring it can be determined whether to cache content or at least a part of content that has been downloaded by at least one user and has the potential to become popular or has become popular. The determination of the content for caching may be based on one or more policies (which may include rules, filters; conditions; and so on) that are predefined in an appropriate function. The policies may be dynamic and change over time or may be defined for particular times or for particular network conditions. The policies may be used to specify various conditions or rules which the content, requests for content or the determination of the content to be cached should comply with. For example, policies may define the number of content downloads and/or proportion of data of the entire content file that needs to be detected before the content is determined as something that shall be cached. Policies may also define actions based on, for example, on different identities of the parties such as the identity of a content provider or the identity of a subscriber (user requesting the content). Policies may also take into account whitelists and blacklists, in other words, lists explicitly defining what to cache and/or what not to cache. The policy may also define which content requests, subscriptions and/or downloads are, or are not, to be monitored. Content providers may also wish that their content is excluded from being cached and distributed in this manner and so the content providers may mark their published content to be included or excluded. The ability to, via the predefined policies, identify content and apply different actions to the content to be cached further enhances many of the embodiments. For example, the caching may be utilised to support different business relationships by, for instance, prioritising data belonging to a specific customer.

In a further example, different service classes or service level agreements may be implemented such that if content is categorised as a “gold” category content then the system may guarantee that the content will be cached (where space may be made available in the cache by removing lower category content if space is required).

As will be appreciated any number of policies may be predefined with any condition or rule that any entity in the system may wish to be applied. The policies may be dynamically defined and modified.

In the following a certain exemplifying use scenario is described with reference to a wireless or mobile communication system of FIG. 4 serving mobile communication devices 51. A mobile communication device is typically provided wireless access via at least one base station or similar wireless transmitter and/or receiver node of an access system. In FIG. 4 base station 54 provides a radio service area serving the mobile communication devices. It is noted that any number of stations can be provided in a communication system and in a local service area. Each mobile communication device and base station may have one or more radio channels open at the same time and may send signals to and/or receive signals from more than one source

Base stations are typically controlled by at least one appropriate controller apparatus so as to enable operation thereof and management of mobile communication devices in communication with the base stations. FIG. 4 shows control apparatus 55. The control apparatus can be interconnected with other control entities. The control apparatus can typically be provided with memory capacity and at least one data processor. The control apparatus and functions may be distributed between a plurality of control units. Each base station can comprise a control apparatus or two or more base stations may share a control apparatus.

A non-limiting example of the recent developments in communication system architectures is the long-term evolution (LTE) of the Universal Mobile Telecommunications System (UMTS) that is being standardized by the 3rd Generation Partnership Project (3GPP). As explained above, further development of the LTE is referred to as LTE-Advanced. The LTE employs a mobile architecture known as the Evolved Universal Terrestrial Radio Access Network (E-UTRAN). Base stations or base station systems of such architectures are known as evolved or enhanced Node Bs (eNBs). Other examples of radio access include those provided by base stations of systems that are based on technologies such as wireless local area network (WLAN) and/or WiMax (Worldwide Interoperability for Microwave Access).

The radio system can be connected to a wider data communication system 57 via an appropriate gateway apparatus 56. One or more content providers 52 can also be connected to the data system. Thus the mobile communication devices 51 can connect to the content provider(s) 52 via the radio system 54.

FIG. 4 shows also a control apparatus 50 and a local storage 56 associated with the controller 55 of the radio system. These apparatuses can be adapted to provide the monitoring and data collection and local storage functions as described above.

The embodiments may thus provide various advantages. Content storage decisions can be based on information of content that is actually downloaded and used, and not just on content requests that do not necessary reveal how much of the content and/or downloads was in reality of interest to users. The threshold for the part that should be consumed by the requestor for being a meaningful for cache decision making can be adjusted based on local policies. Local policies can bypass the statistical information. Previously stored content may gradually lose its popularity so that only a fraction of the content tends to be downloaded. Once the part of the content that is actually used becomes small there is less reason to maintain the full version of the content in the cache. Instead, only a part of it may be cached, e.g. only the most used chunks may be stored in a local storage. Certain embodiments may provide a more optimal and/or efficient use of caching and transport resources. By caching content that is popular, e.g. being downloaded a predefined number of times, a network operator may save in communication costs, because the content may be provided by a cache that is inside the network operator's network. In other words, by bringing a content source closer to the demand for the content the network operator may receive efficiencies in cost, resource usage, latency and performance.

The caches do not need to be on the content delivery path. The caching mechanism may be used as additional functionality for the existing networks, such as the Internet, and in parallel with the existing caching mechanisms.

An appropriately adapted computer program code product or products may be used for implementing the embodiments, when loaded or otherwise provided on an appropriate data processing apparatus. The program code product for providing the operation may be stored on, provided and embodied by means of an appropriate carrier medium. An appropriate computer program can be embodied on a computer readable record medium. A possibility is to download the program code product via a data network. The embodiments may enable flexible integration of new communication service providers in a cloud platform. Downtime can be avoided, or at least minimized. This can result constant up-time of applications using the platform.

It is noted that whilst examples have been described in relation to certain architectures, similar principles can be applied to other data communication and computer systems. Therefore, although certain embodiments were described above by way of example with reference to certain exemplifying architectures for wireless networks, technologies and standards, embodiments may be applied to any other suitable forms of communication systems than those illustrated and described herein. It is also noted that different combinations of different embodiments are possible. It is also noted herein that while the above describes exemplifying embodiments of the invention, there are several variations and modifications which may be made to the disclosed solution without departing from the spirit and scope of the present invention.

1. A method for a data communication system, comprising
monitoring data sessions provided in response to service requests,
determining, based on the monitoring, information regarding data communicated from at least one data source during the monitored sessions,
collecting statistical information based on the determining, and
causing performance of at least one operation based on the statistical information.

2. A method as claimed in claim 1, wherein the at least one operation comprises at least one of
controlling storing and/or deletion of content data;
controlling local caching of content data and/or evicting of locally cached content data;
publishing and/or un-publishing locally available content data; and
determining possibility of a denial of service attack.

3. A method as claimed in claim 1, wherein the monitoring comprises monitoring for downloads in association with a local node of a radio system serving a requestor.

4. A method as claimed in claim 1, wherein the determining comprises reading header information from the data communicated during the session and using the header information in determining the proportion of a full data file that was actually communicated.

5. A method as claimed in claim 1, comprising analysing information contained within headers of content data to determine characteristics of downloaded content.

6. A method as claimed in claim 1, wherein the monitoring comprises identifying content data.

7. A method as claimed in claim 1, wherein the statistical information is based on information about actual usage of content data.

8. A method as claimed in claim 1, comprising providing information on use of different fractions of content data and causing at least one operation on at least one fraction of the content data.

9. A method as claimed in claim 1, comprising determining the proportion of data that was delivered of a full data file.

10. A method as claimed in claim 1, comprising monitoring data sessions by a plurality of information collection points and reporting information to a collection point.

11. A method as claimed in claim 1, comprising determining popularity of a particular data.

12. A method as claimed in claim 1, wherein
the monitoring is provided on the data path between a content provider and a requestor, or
the monitoring is provided off the data path between a content provider and the requestor based on a duplicate of content data downloaded by the requestor.

13. A method as claimed in claim 1, comprising selecting at least one local content storage and causing downloading or removing of content in the selected local data storage.

14. A method as claimed in claim 1, comprising analysing content data to create additional information for the control operations describing at least one characteristics of the content.

15. An apparatus for a data communication system, configured to determine, based on monitoring of data sessions provided in response to service requests, information regarding data communicated from at least one data source during the monitored sessions, collect statistical information based on the determining, and cause performance of at least one operation based on the statistical information.

16. An apparatus as claimed in claim 15, configured to cause at least one of storing and/or deletion of content data, local caching of content data and/or evicting of locally cached content data, publishing and/or un-publishing locally available content data, and determining possibility of a denial of service attack.

17. An apparatus as claimed in claim 15, configured to read header information from the data communicated during the session and use the header information in determining the proportion of a full data file that was actually communicated.

18. An apparatus as claimed in claim 15, configured to determine the statistical information based on information about actual usage of content data.

19. An apparatus as claimed in claim 15, configured to determine information on use of different fractions of content data and cause at least one operation on at least one fraction of the content data.

20. An apparatus as claimed in claim 15, configured to determine the proportion of data that was delivered of a full data file.

21. An apparatus as claimed in claim 15, configured to determine popularity of a particular data.

22. An apparatus as claimed in claim 15, configured to select at least one local content storage and cause downloading or removing of content in the selected local data storage.

23. A computer program comprising program code means adapted to perform the steps of claim 1 when the program is run on a data processing apparatus.
